(19) United States
(12) Patent Application Publication
(10) Pub. No.: US 2011/0139625 A1
(43) Pub. Date: Jun. 16, 2011

(54) Multiphase Fluid Separator

(76) Inventors: Richard Arntzen, Lysaker (NO); Morten Hana, Lysaker (NO); Geir Vingelven, Lysaker (NO)

(21) Appl. No.: 12/162,090

(22) PCT Filed: Dec. 21, 2006
(86) PCT No.: PCT/IB06/04101

§ 371 Date: Mar. 31, 2009

(30) Foreign Application Priority Data
Jan. 26, 2006 (GB) 0601541.6

(51) Int. Cl. B04B 5/10

(52) U.S. Cl. 204/662; 204/660

(57) ABSTRACT

A multiphase fluid separator comprises coalescer means for increasing droplet size in a liquid having droplets of a first phase carried by a second phase, and fluid collecting means for separating the first and second phases. The coalescer means and the fluid collecting means are configured to have a common liquid level. In another aspect, a multiphase fluid separator comprises a vessel housing a compact electrostatic coalescer, and gas separating means. The gas separating means is configured to separate gas from incoming fluid before the fluid enters the compact electrostatic coalescer.

The present invention relates to a multiphase fluid separator. More particularly the invention relates to a separator suitable for use with well-stream fluids in the production of oil and gas.

In oil and gas production the fluid extracted from a well consists of a mixture of oil, gas and water. In addition solids, particularly sand particles, may be carried with the fluids. Before the fluids can be processed, it is necessary to separate the constituent phases. A variety of process techniques and equipment may be used to perform the separation of the phases. In offshore production separation equipment has usually been installed on a production platform. However, there is limited space and weight capacity available on platforms. One alternative has been to place equipment sub-sea, so that processes can be carried out on the well-stream fluids before they are fed to the platform. Also, because the water fraction in well stream fluids can be high, if the water can be separated sub-sea there is a significant saving to be made in terms of the quantity of fluid that needs to be fed to the surface.

A particular problem arises with the separation of water from oil. Frequently the water phase is in the form of an emulsion of very small droplets dispersed in the oil phase. Although the two phases will separate under gravity if allowed to settle, this process takes time, requiring a very large settling vessel.

Installing process equipment sub-sea places special demands on the equipment, which is required to perform without human intervention or maintenance for extended periods. For this reason, the number of components and complexity of plant needs to be kept to a minimum. One problem arises with the control of liquid levels. Many types of process equipment only operate effectively if the liquid level in the equipment is maintained within certain limits. This may be achieved by means of dedicated level control equipment, but this increases the complexity and the number of components.

Also, for both sub-sea, and platform installations, separation process equipment must be capable of operating at high pressure. Every pressure vessel has to be manufactured and tested to meet stringent pressure vessel standards.

The present invention has been conceived with the foregoing in mind.

According to a first aspect of the present invention there is provided a multiphase fluid separator comprising: coalescer means for increasing droplet size in a liquid having droplets of a first phase carried by a second phase; and fluid collecting means for separating said first and second phases; wherein the coalescer means and the fluid collecting means are configured to have a common liquid level.

It is an advantage that, by configuring the coalescer and collecting means so that they have a common liquid level, a single level control means can be employed, thereby minimising the component count.

In a preferred embodiment the coalescer means is a compact electrostatic coalescer (CEC) having a high intensity electric field acting on the liquid as it flows through a narrow flow gap under non-laminar flow conditions. It is an advantage that this type of coalescer is effective in coalescing water droplets and breaking down emulsions, while being of a small size (compared with other known types of coalescer).

In embodiments of the invention, means may be provided for substantially equalising gas pressures in a space above the liquid level in the coalescer means and a space above the liquid level in the collecting means. The means for equalising gas pressures may comprise a duct interconnecting the spaces above the liquid level.

Embodiments of the invention may further comprise means for controlling the liquid level. The means for controlling the liquid level may comprise a level gauge in the collector means and a flow regulating valve situated downstream of the coalescer means.

According to a second aspect of the present invention there is provided a multiphase fluid separator comprising a vessel housing:
(i) a compact electrostatic coalescer, and
(ii) gas separating means,
   wherein the gas separating means is configured to separate gas from incoming fluid before the fluid enters the compact electrostatic coalescer.

In one embodiment, the CEC comprises an inlet for fluid in communication with a top region of the CEC via an inner duct, wherein the inner duct is disposed within an inner electrode of the coalescer. The CEC may be configured to coalesce droplets in liquid flowing in an annular region surrounding the inner electrode.

The gas separating means may comprise a gravitational degasser. The gravitational degasser may be disposed above the coalescer means, the degassing means and the coalescer means sharing the same liquid level.

Alternatively, the degassing means may comprise centrifugal degassing means. The centrifugal degassing means may comprise a cyclonic degasser, which may be a compact cyclonic degasser (CCD). The cyclonic degasser may comprise a plurality of cyclones. Preferably, the centrifugal degassing means includes one or more vortex finders, the vortex finders having an extended height to facilitate degassing over a wide range of liquid levels in the separator. Alternatively, the centrifugal degassing means comprises a compact tubular coalescer (CTC).

The degassing means and the coalescer means may be housed within an integral vessel.

The multiphase fluid separator may further comprise means for separating solids from the fluids. The means for separating solids may comprise a sand removing apparatus. The means for separating solids may be provided upstream and/or downstream of the coalescer.

In embodiments of the invention, the fluid collecting means may be a settling tank or a separator tank. The fluid collecting means may be configured such that solids accumulate therein, the multiphase separator further comprising means for removing solids from the fluid collecting means. The means for removing solids may comprise fluidizing means for fluidising the accumulated solids. Preferably flushing means are provided for flushing away the solids with pressurized liquid. The removed solids may then be conveyed to join an outlet for separated oil and/or gas. It is an advantage that, after water has been separated, a single piping system can be used for transporting oil/gas and solids.

In embodiments of the invention, separated water is conveyed to a water outlet. Because it is nearly impossible to achieve complete separation of the water and oil phases, the separated water will usually contain some emulgated oil. De-oiling means may be provided for separating emulgated oil from the separated water. The de-oiling means may comprise a cyclone separator.

The invention will now be described by way of example, with reference to the following drawings.

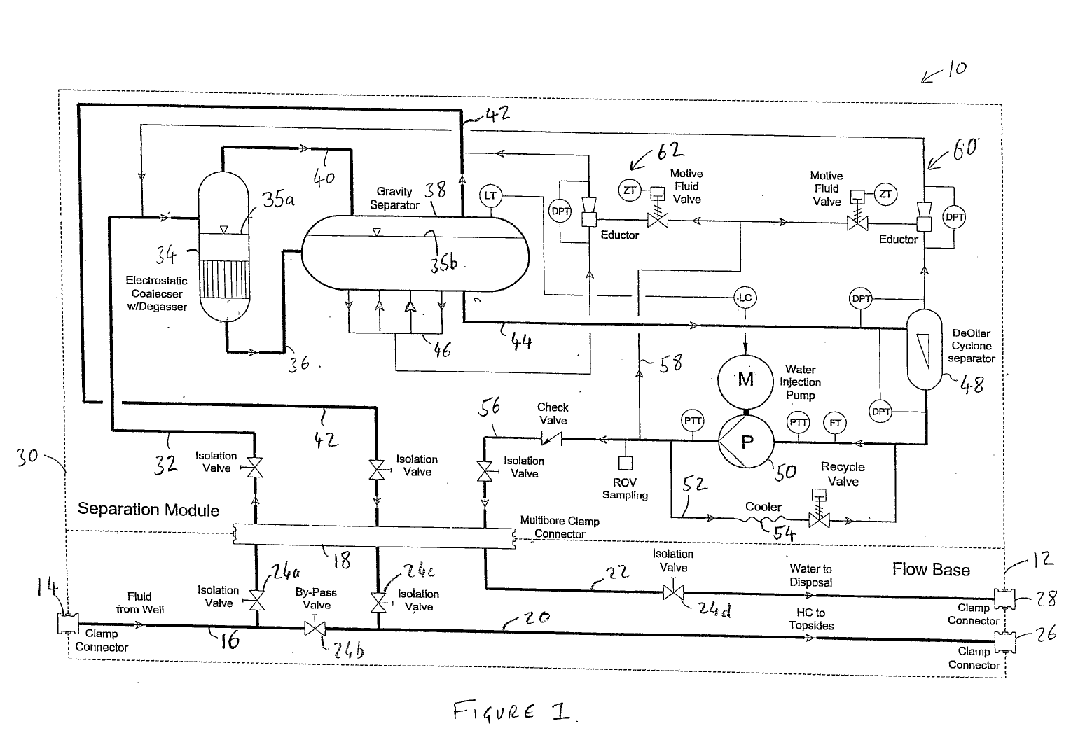

FIG. 1 is a process flow diagram for a multiphase separator plant;

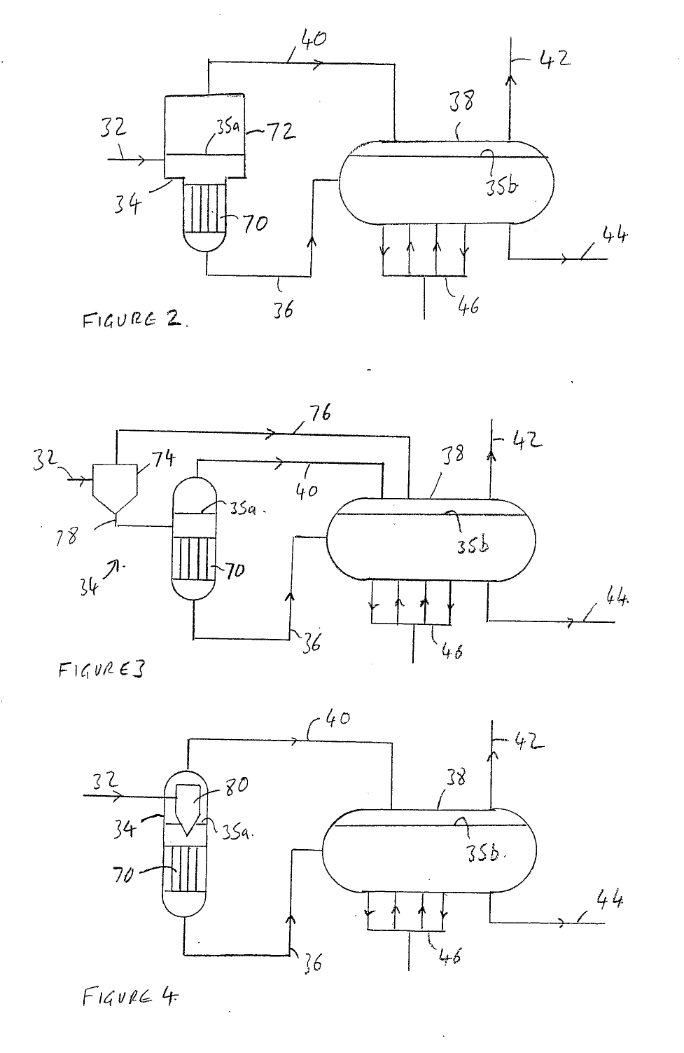

FIGS. 2 to 4 are process flow diagrams showing three different embodiments of part of the multiphase separator plant of FIG. 1.

FIG. 5 is an illustration of one embodiment of part of the multiphase separator plant of FIG. 1

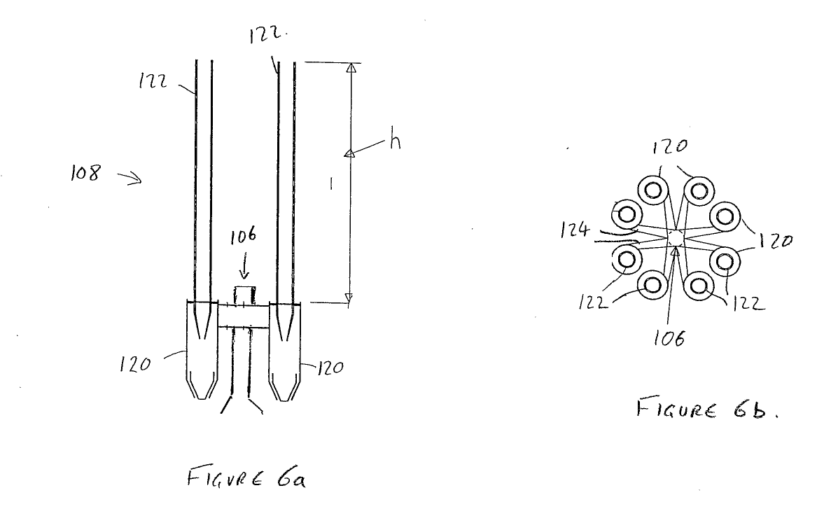

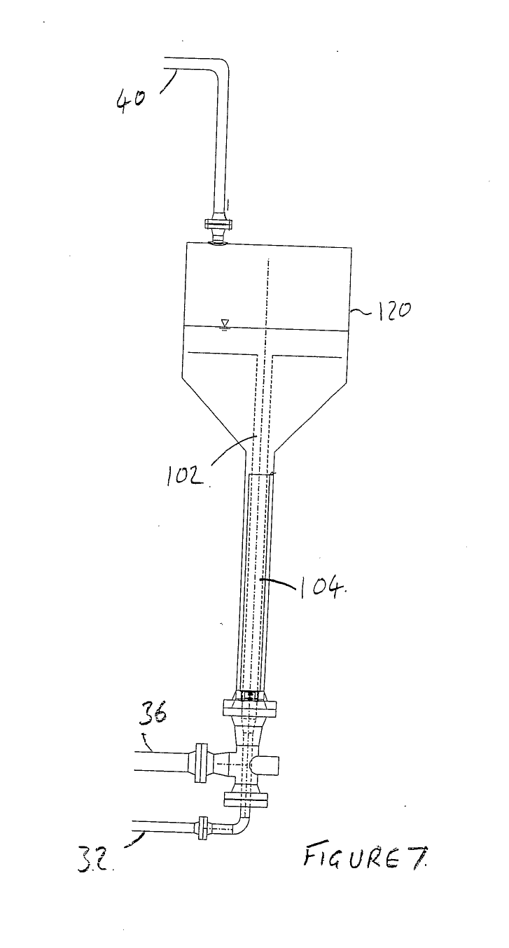

FIG. 6 depicts details of a cyclonic degasser forming part of the plant of FIG. 5.

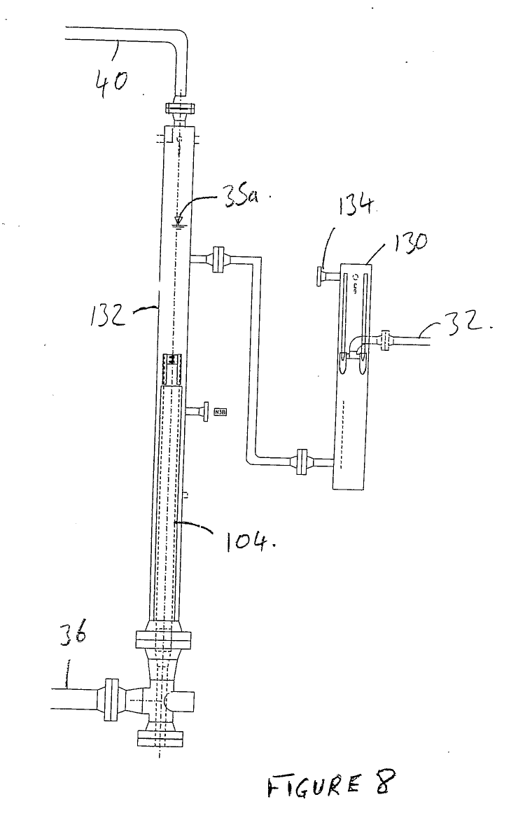

FIGS. 7 to 9 depict alternative arrangements of a degasser and coalescer unit for a multiphase separator plant of the type shown in FIG. 1.

Referring to FIG. 1, a multiphase separator plant 10 includes a flow base 12 coupled to a separation module 30. The multiphase separator plant 10 is configured to be suitable for use sub-sea. The flow base 12 includes a clamp connector 14 to allow quick, watertight and pressure sealed connection sub-sea to a pipe for delivering well-stream fluids into an inlet duct 16. During normal operation, the inlet duct 16 delivers the well-stream fluids to an inlet duct 32 in the separation module 30, by way of a multi-bore clamp connector 18. The flow base 12 also includes an oil outlet duct 20 and a water outlet duct 22. These deliver separated water and oil/gas (hydrocarbons) to corresponding outlet clamp connectors 28, 26, that allow quick, watertight and pressure sealed connection sub-sea to pipes for onward transport. A number of valves 24a-24d are provided for isolating or bypassing the separation module 30 when circumstances require.

In the separation module 30, the inlet duct 32 delivers well-stream fluids to a coalescer and degasser unit 34 that will be described in more detail below. The coalescer and degasser unit 34 has a liquid outlet 36 that leads to a gravity separator, or settling tank 38. As shown in FIG. 1, the coalescer and degasser unit 34 has a liquid level 35a, while the gravity separator 38 has a liquid level 35b. The coalescer and degasser unit 34 and the gravity separator 38 are configured such that the two liquid levels 35a, 35b are a common liquid level. In the embodiment shown, at the top of the coalescer and degasser unit 34, so as to be above the liquid level 35a, a gas outlet duct 40 interconnects with a top region above the liquid level 35b in the gravity separator 38. This interconnecting duct 40 ensures that the gas pressure above the liquid levels 35a, 35b is always the same. As a consequence it is only necessary to monitor and control one liquid level.

The gravity separator 38 has an outlet 42 for separated oil and gas, which returns the separated oil and gas, without the separated water back to the flow base 12 via the multi-bore clamp connector 18 into the oil outlet duct 20.

The gravity separator 38 also has an outlet 44 for separated water, which transports the separated water to a de-oiler cyclone separator 48. The separated water then passes through a pump 50, which raises the water pressure before it is delivered back to the flow base 12 via the multi-bore clamp connector 18 into the water outlet duct 22. A portion of the pressurised water from the pump 50 is fed via a take-off line 58 to operate a first eductor apparatus 60 and a second eductor apparatus 62. The first eductor apparatus 60 is used to draw off oil from the de-oiler separator 48 and return it to the inlet duct 32.

The gravity separator 38 also has a series of ports 46 at its base. These include ports through which fluid can be injected to fluidise solids particles that accumulate at the base of the gravity separator 38. The fluidised particles can then be readily flushed out of the gravity separator 38. The flushed out solids are then drawn away the second eductor apparatus 62 and fed into the separated oil/gas outlet duct 42 to be transported away via the oil outlet duct 20 in the flow base 12. Note that, in this embodiment, the separation of solids in the gravity separator is a by-product of the separation process. As the volumes of solids are usually quite low (in comparison to the gas and liquid volumes) it is a simple remedy, to avoid accumulation of excessive quantities of solids, to return these to the oil/gas outlet flow stream. This avoids the need for a separate solids handling apparatus.

The well-stream fluid enters the multiphase separator 10 through the flow base 12 and is fed to the coalescer and degasser unit 34, that includes a degassing portion and a coalescing portion. Initially the gas is separated from the liquids in the degassing portion, various embodiments of which will be described in more detail hereafter. The separated liquid contains a mixture of oil and water. Frequently the water phase is in the form of an emulsion of very small droplets dispersed in the oil phase. Although the two phases will separate under gravity if allowed to settle, this process takes time, and would require a very large gravity separator settling vessel.

To reduce the time for separation, the coalescer is used to break down the emulsion by coalescing the water droplets into larger droplets before feeding the mixture to the (much smaller) gravity separator 38. An effective way of doing this is by means of an electrostatic coalescer. EP1082168 describes a particularly effective compact electrostatic coalescer (CEC). This equipment utilises a high intensity electric field acting on the emulsion as it flows through a narrow flow gap under non-laminar flow conditions. The emulsion is introduced into the top of a vertically mounted cylindrical vessel or shell, and flows through one or more narrow, annular flow gaps formed between one or more electrodes, or an internal wall of the device. The broken emulsion is discharged from the bottom of the vessel, after having a short residence time in the high-intensity electrostatic field. The non-laminar flow of emulsion in the narrow, annular flow gaps means that effective coalescing of water droplets can be achieved a small size of equipment, even with emulsions having high water content.

FIG. 2 shows a portion of a multiphase separator of the type shown in FIG. 1, including more details of an embodiment of the coalescer and degasser unit 34 and the gravity separator 38. In this embodiment, the coalescer and degasser unit 34 includes a gravity separator degasser 72, in which the liquid phase constituents (oil and water) drop down, allowing the gas phase to separate into the space above the liquid surface 35a. This type of degasser requires a sufficiently large surface area to enable the gas to separate from the liquid. A CEC 70 is located underneath the gravity separator degasser 72.

The outflow from the CEC 70 contains oil and coalesced water droplets, and this is fed to the gravity separator 38, where the oil and water phases separate. It is important for the electrodes of the CEC to be fully immersed in liquid, which is why the level of the surface 35a needs to be controlled. The level may fluctuate, depending on the relative volumes of gas and liquid in the incoming well-stream fluids. To ensure that there is sufficient liquid in the system to prevent the level dropping below the top of the electrodes in the CEC 70, the liquid level 35a in the degasser 72 is maintained in common with the level 35b in the gravity separator 38. This is achieved because the interconnecting duct 40 maintains a common gas pressure in the two vessels. The level may be controlled by means of a level in sensor in either vessel and a control valve located downstream, for example in the oil/gas outlet 42 and/or the water outlet 44.

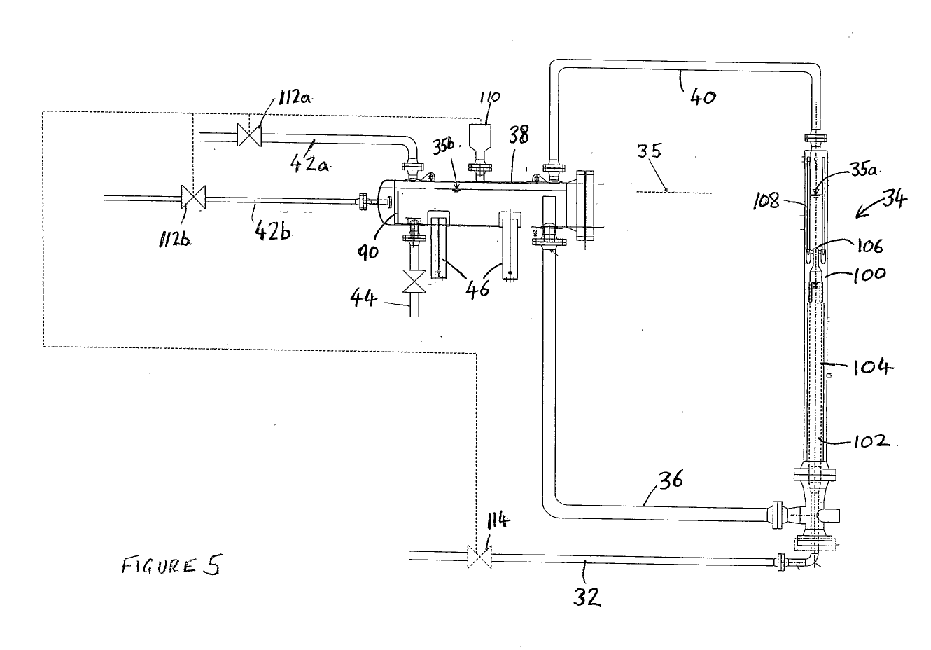

FIG. 3 shows an alternative embodiment of the coalescer and degasser unit 34. Here there is a separate cyclonic degasser 74 situated upstream of the CEC 70. Separated gas from the cyclonic degasser 74 passes through an interconnecting duct 76 to the gravity separator. Separated liquid from the cyclonic degasser 74 is fed through an underflow 78 to the CEC 70. The liquid level 35a above the CEC is maintained in common with the liquid level 35b in the gravity separator 38.

One example of the cyclonic degasser 74 is a compact cyclonic degasser (CCD) marketed by Aker Kvaerner Process Systems under the name of G-Sep™ CCD). The incoming fluids enter a cyclone, where gas and liquid is separated by centrifugal action while the bulk of the liquid leaves through the cyclone underflow. The gas is then routed through a vortex finder at the top of the cyclone and into a scrubber section, where liquid droplets are removed.

Another example is described in WO99/25454, where a gravity separator has a cyclone separator at its inlet. The cyclone separator separates incoming fluids into gas and liquid phases. The centrifugal forces also help to break down foam into gas and liquid phases. A device of this type is marketed by Aker Kvaerner Process Systems under the name of G-Sep™ (CCI).

FIG. 4 shows an alternative to the arrangement of FIG. 3. Here a cyclonic degasser 80 is situated inside the same vessel as the CEC 70. The liquid outlet from the underflow of the cyclonic degasser 80 is blow the liquid level 35a, while gas leaves the degasser 80 through the top of the vessel via the interconnecting duct 40 to the gravity separator 38.

FIG. 5 depicts the equipment used in the process shown in FIG. 4. The same reference numerals have been used for equivalent components. The coalescer and degasser unit 34 includes a vertically mounted cylindrical vessel 100. The well-stream fluids from the inlet pipe 32 enter the coalescer and degasser unit 34 at or near its base and then pass up through a central tube 102. The central tube 102 passes up inside a central, inner electrode of the CEC 104. the fluids emerge through openings 106 above the CEC 104, which openings form part of an inlet arrangement for a cyclonic degasser 108, details of which are described hereafter.

Gas leaves the degasser 108 through the top of the cylindrical vessel 100 and passes through a pipe forming the interconnecting duct 40 to the gravity separator 38. The separated liquids flow down from the degasser 108 through the CEC 104 where the intense electric filed coalesces the water droplets and breaks down the water/oil emulsion. The liquids are fed to the gravity separator 38 through the liquid outlet pipe 36. Separated water phase leaves the gravity separator 38 through the water outlet 44, while the oil and gas phases leave through one or other of the oil/gas outlets 42a, 42b. In some circumstances both gas and oil may be fed together through the outlet 42a, while in other circumstances, where it is required to provide separate gas and oil feeds, oil only is fed through the outlet 42b. An internal weir arrangement 90 ensures that only oil can reach the outlet 42b.

A level gauge 110 monitors the liquid level 35b in the gravity separator 38. An output from the level gauge 110 is used to control any or all of control valves 112a, 112b and 114 (depending on the outlet circumstances and the preferred control methodology). In this way the liquid level 35b in the gravity separator is controlled within pre-specified limits. Also, because the interconnecting pipe 40 ensures that the gas pressures in the gravity separator and the degasser are equal, the common liquid level 35a in the degasser is controlled.

FIG. 6a is a view in elevation, and FIG. 6b is a plan view, showing more detail of the cyclonic degasser 108 shown in FIG. 5. Well-stream fluids enter the degasser 108 through the inlet arrangement 106. This includes a plurality (8 are shown) of cyclone chambers 120. The fluids enter the cyclone chambers 120 through respective tangential ducts 124. This creates a swirling motion in each of the cyclone chambers 120 resulting in separation of the gas and liquid phases. Associated with each cyclone chamber 120 is a vortex finder 122.

In the swirling motion in each cyclone chamber 120, the denser liquid phase migrates to the outside and flows down the walls of the chamber 120, while the gas phase migrates to the centre from where it passes out upwards through the vortex finder 122. The liquid emerging from the bottom of each cyclone chamber enters the surrounding space and will find a level above the inlet arrangement 106 (depending on the prevailing pressure and flow conditions). To ensure that the degasser 108 does not become flooded (in which liquid spills over the tops of the vortex finders 122, the vortex finders have an extended height h. The level control arrangement described above with reference to FIG. 5 ensures that the liquid level remains below the tops of the vortex finders 122.

FIGS. 7, 8 and 9 depict alternative arrangements of the coalescer and degasser unit 34. In FIG. 7, the cyclonic degasser 108 of FIGS. 5 and 6 is replaced with a gravitational degasser 120 (as described in relation to FIG. 2). The gravitational degasser 120 occupies a vessel having a considerably larger diameter than that of the cylindrical vessel 100 of the CEC and cyclonic degasser shown in FIG. 5. The larger diameter is used to ensure effective degassing under gravity.

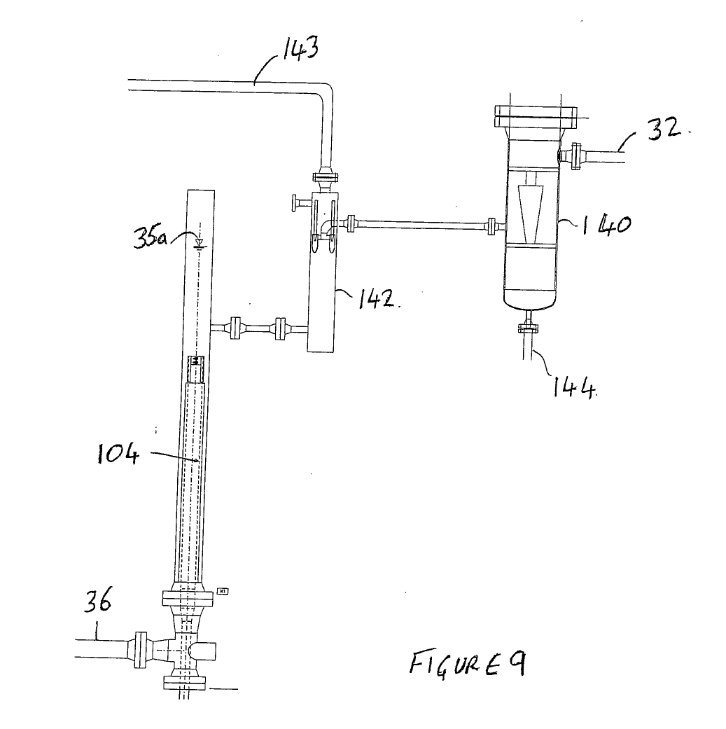

The equipment depicted in FIG. 8 corresponds with the process flow diagram of FIG. 3. Here a separate cyclonic degasser 130 is used to provide a feed of liquids to a cylindrical vessel 132 in which the CEC 104 is housed. The liquid level 35a in the cylindrical vessel 132 is common to that of the gravity separator 38 (see FIGS. 1 and 5), ensuring that the CEC electrodes are immersed in liquid. The separated gas leaves the degasser 130 via a gas outlet 134, which may lead to the gravity separator 38, or may be taken off as a separate feed.

FIG. 9 depicts an arrangement similar to that of FIG. 8, except that an additional de-sander 140 is included upstream of a cyclonic degasser 142. The de-sander 140 removes solid particles (e.g. sand) from the fluids before these are separated further. A sand outlet 144 is provided so that the solid particles can be discharged from the de-sander 140. The multiphase separators described above are able to tolerate a certain amount of particulate solid matter carried with the incoming well-stream fluids, because these will settle out in the gravity separator. However, in some circumstances (for example if there is a very high proportion of solids), then it is better to remove most of the solids before these enter the degasser, so that the separation equipment does not clog.

The cyclonic degasser 142 is similar to that of FIG. 8, except that it includes a gas outlet pipe 143, which communicates with the gravity separator 38 (see FIG. 3). In this case the liquid level 35a above the CEC 104 is the same as that in the cyclonic degasser 142, the level being common with, and controlled from the liquid level in the gravity separator 38 due to equalisation of the gas pressure via the outlet pipe 143.

WO05/035995 describes a type of separator device known as a compact tubular coalescer (CTC). This type of device is also effective as a degasser and may be used instead of, or in addition to the degassers described above. The CTC employs tubes inside which a flowing fluid is caused to swirl. In one example helically twisted vanes extend along the tubes to impart the swirling motion. The swirling motion has a similar effect to that of a cyclone, with the result that liquids tend to migrate towards the inner walls of the tubes, while the gas tends to migrate towards the centre. On exiting the tubes, the gas and liquid phases can readily be separated by suitable redirection of the respective gas and liquid flows. As with the cyclonic degassers described above, a CTC degasser may be employed either as a separate degasser or incorporated into the same vessel as the coalescer.

It will be seen that the embodiments described above provide an improved multiphase separator, particularly suitable for use sub-sea. The combination of a coalescer and degasser unit, in which the liquid level is common with that of a fluid collector (e.g. gravity separator) allows for a single liquid level control means to be employed. Moreover, the use of a CEC, in combination with a degasser provides a particularly compact arrangement requiring minimal interconnecting pipe-work and control apparatus. The degasser and coalescer may be combined in a single pressure vessel, thereby reducing the number of different pressure vessels required.

1-28. (canceled)

29. A multiphase fluid separator comprising:
a degasser for removing a gas phase from a fluid stream entering the separator;
a first vessel comprising a compact electrostatic coalescer (CEC) for increasing droplet size in a liquid having droplets of a first phase carried by a second phase;
a second vessel for separating said first and second phases; and
means for substantially equalizing gas pressures in a space above the liquid level in the first vessel and a space above the liquid level in the second vessel so as to provide a common liquid level in said first and second vessels.

30. A multiphase fluid separator according to claim 29, wherein the CEC has a high intensity electric field acting on the liquid as it flows through a narrow flow gap under non-laminar flow conditions.

31. A multiphase fluid separator according to claim 29, wherein the degasser is a centrifugal degasser.

32. A multiphase fluid separator according to claim 29, wherein the means for substantially equalizing gas pressures comprises a duct interconnecting said spaces above the liquid level in said first and second vessels.

33. A multiphase fluid separator according to claim 29, further comprising means for controlling said liquid level.

34. A multiphase fluid separator according to claim 33, wherein the means for controlling the liquid level comprises a level gauge and flow regulating valve means situated upstream and/or downstream of the first vessel.

35. A multiphase fluid separator according to claim 30, wherein the CEC comprises an inlet for fluid in communication with a top region of the first vessel via an inner duct, wherein the inner duct is disposed within an inner electrode of the CEC.

36. A multiphase fluid separator according to claim 35, wherein the CEC is configured to coalesce droplets in fluid flowing in an annular region surrounding the inner electrode.

37. A multiphase fluid separator according to claim 29, wherein the degasser is disposed above the CEC, the degasser and the CEC sharing the same liquid level.

38. A multiphase fluid separator according to claim 31, wherein the centrifugal degasser comprises a cyclonic degasser.

39. A multiphase fluid separator according to claim 38, wherein the centrifugal degasser includes one or more vortex finders, the vortex finders having an extended height to facilitate degassing for a range of liquid levels in the separator.

40. A multiphase fluid separator according to claim 31, wherein the centrifugal degasser comprises a compact cyclonic degasser (CCD).

41. A multiphase fluid separator according to claim 31, wherein the centrifugal degasser comprises a compact tubular coalescer (CTC).

42. A multiphase fluid separator according to claim 29, wherein the degasser and the CEC are both housed within said first vessel.

43. A multiphase fluid separator according to claim 29, further comprising means for separating solids from the fluids.

44. A multiphase fluid separator according to claim 43, wherein the means for separating solids comprises a sand removing apparatus.
